(19) United States
(12) Patent Application Publication
(10) Pub. No.: US 2002/0040405 A1
(43) Pub. Date: Apr. 4, 2002

(54) Gateway device for remote file server services

(76) Inventor: Stephen Gold, Winterboume Down (GB)

Correspondence Address: HEWLETT-PACKARD COMPANY, Intellectual Property Administration, P.O. Box 272400, Fort Collins, CO, 80527-2400, US

(21) Appl. No.: 09/922,082

(22) Filed: Aug. 3, 2001

(30) Foreign Application Priority Data
Aug. 4, 2000 (GB) 0019015.7

(51) Int. Cl. G06F 15/16

(52) U.S. Cl. 709/231; 709/217

(57) ABSTRACT

A bulk data repository 201 for remote storage of bulk data from a plurality of computer networks 200-207 is accessed over a plurality of communications links, e.g., the internet 202. Each computer network is provided with a gateway appliance 200, which acts as a virtual filing system for a plurality of computer entities on a computer network. Gateway appliance emulates a file system, for example Windows NT™ or Novell NetWare™ by packaging data files to be stored in files for transmission over the communications linked to the data repository, each data file having appended a meta data header, which designates an address of the gateway appliance and a type of file system which the gateway appliance is emulating. The data repository, receives the data file with the meta data header, and stores the met data header locally in a local database prior to filing the data file. In a block of data reserved for the gateway appliance. The data repository can search data files by searching the meta data header to locate any of the data files of a gateway appliance. The data repository has automatic management tools for monitoring the amount of data storage space allocated to any gateway appliance, and for expanding the allocated data storage space if required.

### FIELD OF THE INVENTION

The present invention relates to computer networks, and particularly, although not exclusively, to a method and apparatus for providing remote data storage for one or more computers, over a communications network.

### BACKGROUND TO THE INVENTION

Conventionally, in a network of computers, for example a corporate network, the primary means of data storage tends to be provided by one or a plurality of file server and/or applications server devices in a same geographical location.

A user running a plurality of conventional file servers across a company network requires management of the server hardware, in addition to the normal user management. Conventional file server based local are networks are not readily scaleable, without reconfiguration of file servers. For example, users may have to be transferred from one file server to another, and the file structures on the file server need to be managed to ensure a smooth migration of users, as well as requiring management of different security levels and user accesses. Maintaining capacity in a file server based local area network of computers can become management intensive.

A potential solution for this problem are the known storage area networks (SANs). However, these tend to be economically feasible only for very large corporations which can afford high end enterprise storage infrastructure. For small companies having of the order of 100 or 200 computer users, purchasing an extra few terabytes of data storage such companies must either buy a whole set of new servers, configure, maintain and manage them, and then manage the users across all the servers.

An alternative solution to data storage for individual computer users, or users of network of computers is to provide the user with a network connection over which they can remotely store files, instead of the user buying and maintaining their own file servers. Such a network connection would link to a remote data storage facility and may potentially provide a user with a much lower cost of ownership per gigabyte of file storage compared with the user buying and maintaining their own file servers. A service provider, running the data storage facility would take on responsibility for data protection.

One problem with providing a remote file server service is the bandwidth of the network connection between the user and the service provider. This network connection needs to be very high performance in order to handle all the read and write traffic from users to a centralized remote file server service. This is not only expensive, but also difficult to deploy. In practice, there is a limited amount of data transmission capacity over which to pass large amounts of data back and forth between a computer and a centralized data storage facility.

A second problem is that a service provider operating a data storage facility has no idea how a user wishes to use the data storage facility at the user's end of the network connection. Data storage is always conventionally used with features such as a file structure, security, user accesses and the like. There is a problem for the service provider in how to accommodate the flexibility of user's own configurations of the data storage space, for a plurality of different users.

### SUMMARY OF THE INVENTION

Specific implementations of the present invention aim to provide a remote data storage service which can use a relatively low data rate networking connection, but still provide fast read and write access to user files. By low, it is meant low data rate compared with data rates available within prior art local area network connections, such as Ethernet, as are found in many prior art local area networks. There is provided a file server service gateway appliance which interfaces between a customer and a data storage service provider via a network connection, for example an integrated services digital network (ISDN) line or a T1 connection.

Using a specific implementation of the present invention, there may be provided a solution that the customer may request a service provider of the data repository to make available an extra quantity, e.g. a terabyte or so of data storage space in the data repository. Ideally from the customers point of view, the amount of data storage expands, without the associated problems of the prior art network data servers, of moving users between different file serves. This makes the cost of usage of bulk data repository facilities attractive, provided the problem of limited data capacity on the communications links can be satisfactorily solved.

In specific implementations of the present invention, a network user may specify configuration of a remote data block in a data repository, allocating different users to have permissions to different files and specifying that the data storage space should support their particular operating system, for example Windows NT™, Unix™ or the like, from the client network. Effectively, management of a data block, once allocated to a customer, is performed by the customer themselves. The large volume of data storage in the data repository is divided into a plurality of blocks, allocated to different customers, and each customer manages the file storage within their own data block themselves. The problem of restricted data capacity between the data repository and the gateway appliance is overcome by local caching of data at the gateway appliance prior to sending compressed data transmission files comprising user data and a file header over the communications link. Data is stored in the data repository in compressed format. Transmission of data files is made at user definable periodic intervals, and local caching of user data enables recently written user data files to be recovered without needing to retrieve data from the data repository over the communications link. Further, incremental changes to written data files which are stored in the lock gateway appliance cache are periodically collected together and sent to the data repository where they are stored as incremental data files, without merging them at the data repository, with the original data files.

According to a first aspect of the present invention, there is provided a method of storing user data of a plurality of network computer entities, said method characterized by comprising the steps of:

writing said user data to a local data storage area (1001) in a said computer entity;

creating an emulation data which emulates a file system type in use in said network;

incorporating said user data and said file system type data in a data file for transmission; and

transmitting said transmission file over a communications link for remote data storage.

According to second aspect of the present invention there is provided a method of preparing data originating from a plurality of networked computer entities into a format for remote storage, said method comprising the steps of:

assembling a file of user data to be remotely stored;

assembling a header data (1102), said header data comprising:

an address data (401) identifying an address of a device from which said data is sent;

a file system type data (400) identifying a file system type which is used by the device from which the data is sent;

an access control data (404) describing at (east one category of user who is authorised to access said user data files;

a timing data (405) identifying a time associated with said user data file; and

appending said header data (1103) to said user data file to create a transmission file comprising said user data file and said header data.

According to a third aspect of the present invention there is provided a gateway appliance for sending data to and receiving data from a remote data storage location accessible over a communications link, said gateway appliance comprising:

a data processor (1002);

a first of communications port (1004) for communicating with a plurality of computers in a computer network;

a second communications (1005) port for communicating with a remote data storage facility;

a nonvolatile data storage device (1001) for storing locally, data to be communicated via said second port;

means (1001) for emulating a file system corresponding to a file system of a network of computer entities;

means for converting data between a file system dependent format and a file system independent format; and

means for converting said data between a compressed format and an uncompressed format.

According to a fourth aspect of the present invention there is provided a bulk data storage facility comprising:

a plurality of data storage devices (500, 601);

a plurality of file servers (501, 602) configured for storing data in said plurality of data storage devices;

a plurality of gateway devices (502, 603) providing external connectivity to said plurality of file servers and adapted to receive packets of incoming data;

said bulk data storage facility characterized by comprising:

means (604) to allocate said plurality of incoming data packets to data storage space in said plurality of data storage devices; and

database means (1301) for recording a data location of each said plurality of data packets in said plurality of data storage devices.

According to a fifth aspect of the present invention there is provided a method of providing data storage to a plurality of customers at a bulk data storage repository, said method comprising the steps of:

receiving packets of data from each of said plurality of customers;

allocating (800) to each said customer at least one block of data storage space;

allocating to each said received packet a file location in said data storage space;

allocating to each said packet a file name;

storing (802, 1407) said file name in a database, said database identifying said file location in said data repository associated with said data packet.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a bulk data storage repository facility located geographically remotely from a plurality of corporate user networks, and connected to the corporate user networks over the internet;

FIG. 2 illustrates schematically a relationship between a bulk data storage repository and a single gateway appliance comprising a corporate user network, the gateway appliance connected to the data repository via a communications link, e.g. the internet;

FIG. 3 illustrates schematically a data transmission file for transmitting data between a customer gateway appliance and the data repository of FIG. 2 over a communications link;

FIG. 4 illustrates schematically data types comprising a meta data header field of the data transmission file of FIG. 3;

FIG. 5 illustrates schematically a prior art server duster having a bulk data storage device, having high reliability, high redundancy and scalability.

FIG. 6 illustrates schematically a data repository according to a specific implementation of the present invention comprising a prior art bulk data storage device, controlled by a novel operating system;

FIG. 7 illustrates schematically an internal file structure of a data storage facility of FIG. 6 herein;

FIG. 8 illustrates schematically an overview of a first mode of operation of the data repository of FIG. 6 method for allocating data storage space to a particular gateway appliance of a customer;

FIG. 9 illustrates schematically a second mode of operation of the data repository of FIG. 6 herein, for receiving a data transmission block from a customer gateway appliance and storing data in a bulk data storage device;

FIG. 10 illustrates schematically a gateway appliance according to a specific implementation of the present invention, for linking a customer computer network to the data repository facility illustrated in FIG. 6;

FIG. 11 illustrates schematically an overview of a first method of operation of the gateway appliance of FIG. 10, for sending data to be stored in the data repository of FIG. 6 herein;

FIG. 12 illustrates schematically a data file containing configuration data of the gateway appliance of FIG. 10 herein, which may be stored as a data file in the data repository of FIG. 6 herein;

FIG. 13 illustrates schematically architecture of management module 406 of the data repository; and

FIG. 14 illustrates schematically a third mode of operation of the data repository, upon receiving a data file from a gateway appliance.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

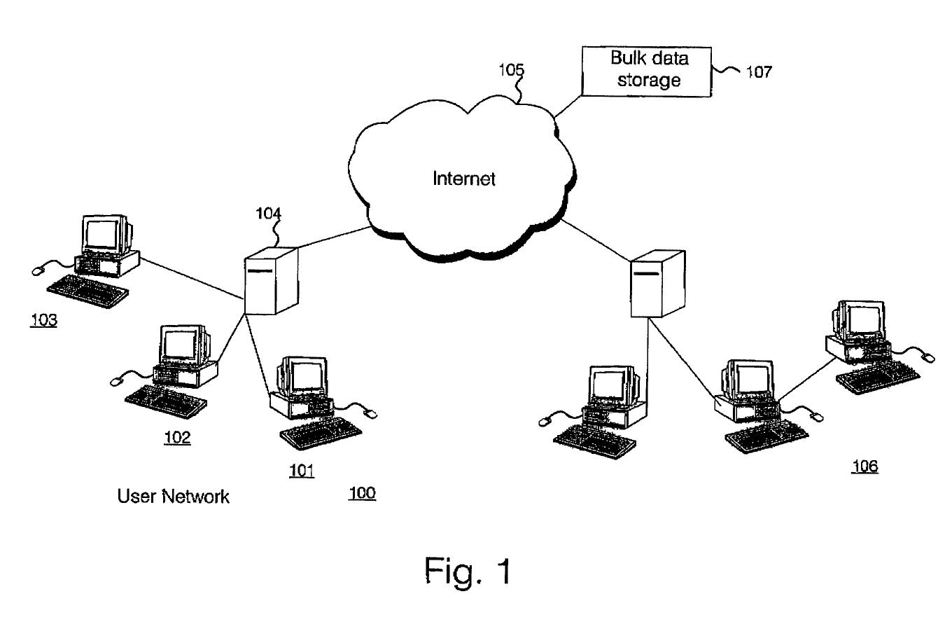

Referring to FIG. 1 herein, there is illustrated schematically a computing system comprising a plurality of user networks 100, 106 comprising a plurality of individual computing entities 101-103 connected together by a local area network, and comprising a gateway device 104 for communicating over a communications link, for example the internet 105, with a bulk data storage apparatus 106 which may be located at a data repository facility 107 located remotely from the user network 100. The bulk data storage unit may store data from a plurality of corporate networks 100, 106, and serves a function of a centralized data storage facility for storage of corporate data, as a replacement for individual corporations purchasing their own data storage devices.

The data repository 107 may be located at any location in the world, and connected to the plurality of corporate networks 100, 106 via dedicated communications lines, for example virtual private networks (VPNs), or via the internet. Practically, the communications link connection between a corporate network and the data repository will not be of unlimited data capacity, but will have capacity limits imposed upon it, either in terms of technical bit rate limitation, or in terms of financial limitations on the purchase of bit rate and data capacity. It is therefore important to efficiently utilize the available bit rate capacity of the communications link between a gateway device 104 and the bulk data repository.

The data repository 107 comprises a large array of data storage devices, with associated processor capacity, providing a bulk data storage facility to a plurality of different computer networks, each of which may be run by a different corporation. The service provider owning and maintaining the data repository 105 provides as a paid for service, provision of data storage to each of the persons managing the corporate computer nets 100, 106, with an advantage that increasing or decreasing the amount of data storage supplied to a corporation can be quickly implemented in response to a customer requesting a greater or lesser amount of data storage.

A main reason for providing a data repository service is cost of ownership compared to individual networked file servers. Further, high reliability, high redundancy and high availability are also advantages over conventional file servers provided on local area networks. To obtain the same reliability and redundancy in a conventional local area network structure would incur higher costs to a user.

At each user network, there may be tens or hundreds of individual persons using the network, any of whom wish to access the data in the bulk data storage repository 107. A single bulk data storage repository 107 may serve hundreds or thousands of individual user networks. For handling multiple users having multiple connections over multiple communication links, e.g. over the internet 105, if users were to configure the bulk data storage space 107 individually to suit their own data security policies, and operating environments, by sending configuration messages over the internet, then at the repository end, there would be a huge management problem in managing the incoming management traffic at the data repository. Authorisation for dividing the data block, e.g. NT authorizations, being transported across the internet should be avoided.

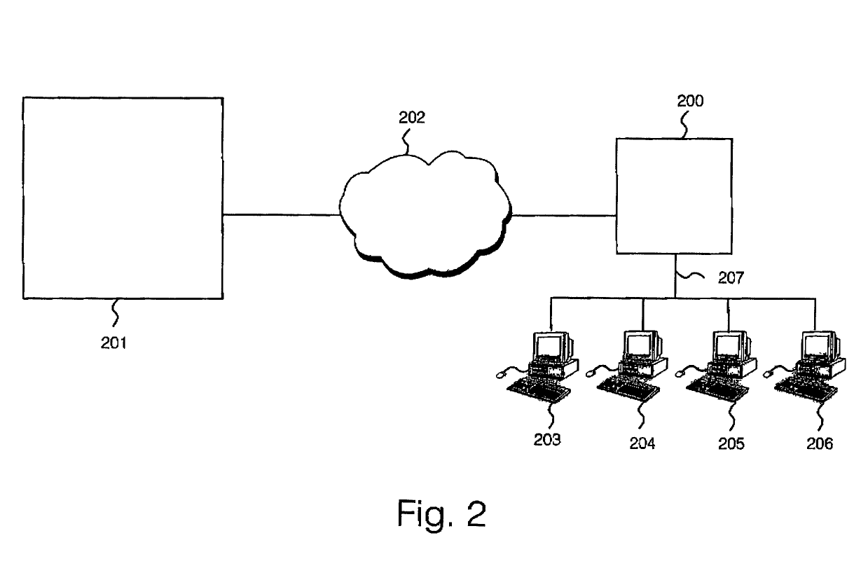

Referring to FIG. 2 herein, there is illustrated schematically a connection between a gateway appliance 200 and a data repository facility 201 over internet 202. Gateway appliance 200 serves a corporate computer network comprising a plurality of individual computer entities 203-206 which are connected via a local area network 207.

The purpose of the gateway appliance includes:

Providing a user with an emulation of a file server which integrates easily into a customer's existing network, for example to emulate an NT server for NT domains, a network server for NDS networks, an NFS server for Unix networks and the like.

To provide performance enhancements so that read and write traffic over a low speed network connection to the service provider is reduced to an absolute minimum without impacting a user's read/write performance to the emulated file server.

Gateway appliance 200 provides an abstraction of a data storage facility available to the user such that users can configure their own storage management schemes from their own user networks. All of the complexity of individual user authorizations, including the details of which individuals can access which files, is dealt with by the gateway appliance 200. The data storage repository 201 serves requests for raw blocks of data storage capacity in response to requests from the gateway appliance.

Emulation of a local file system resident on a computer network is achieved by the gateway appliance providing emulations of the various file server file system types over local area network interfaces in the gateway appliance and also by supporting integration into the various leading network security models, for example NDS, NT Domain, Active Directory. These emulated file systems are mapped to generic ‘raw’ file systems at the data repository, so that when a user writes a new file to an emulated file system, this is stored in the ‘raw’ file system at the repository along with the specific attributes to the file system. Each user in a computer network who is allowed access to the gateway appliance may be assigned a private internal security identification for the ‘raw’ file system, and the gateway appliance converts between the local area network security user identifications, and the internal identifications used in the ‘raw’ file system at the data repository.

Providing such an emulation scheme allows a user to charge the emulated file systems to any size they wish. For example, if a user is running out of space, then a user can purchase additional file server capacity from the data repository service provider, and allocate this additional ‘raw’ capacity to existing emulated file systems, or create new file systems. This means them are no significant restraints on how much ‘raw’ capacity the user can use at the data repository, though if the user had a large amount of capacity, they may wish to add additional local area network interfaces to the gateway appliance to share the local area network traffic.

The gateway appliance uses a local data storage device as an advanced read and write cache to reduce the amount of network traffic between the appliance and the data repository. When a user writes a file to the emulated file system in the gateway appliance, this is initially cached on the appliance data storage device. At regular intervals, which are pre-settable by a user, for example hourly, any files changed since a last transmission to the data repository are sent back to the data repository to be stored in the raw filing system. It means such a redundant file elimination, software compression and delta blocking may be used at the gateway appliance to reduce the amount of traffic traversing the communications link to a minimum. In the data repository, new data is received, decompressed, and deltas are applied to files to bring them up to date with a user's latest file changes. If a user has made multiple changes to a file within a single transmission interval, then these changes may be consolidated before being re-stored in the data repository.

The gateway appliance may cache recently written files which are kept in the local data storage device at the gateway appliance after file transmission. Thus, if a user reads the file again, they may read it from the gateway appliance directly, rather than having recourse to access the data repository over the communications link. This means for many file reader accesses, the user will get full performance (limited by the performance of the gateway appliance) rather than incurring the delay in obtaining files from the remote data repository. Further, the fact that a file is cached locally at the gateway appliance means that a user at a computer entity does not need to continually access the data repository to receive files, which again minimizes use of bit rate capacity over the communications link. For file read accesses that are not cached on the gateway appliance, the appliance may request that file from the data repository in compressed format, and read it back (still compressed) over a network connection from the data repository. As the file arrives at the gateway appliance, the gateway appliance decompresses the file and makes it available for use on the computer network. Given that no write traffic need be incurred, except at transmission times between the data repository and the gateway appliance, then a connection may have full bandwidth available for the majority of non-cached file reads. With an ISDN network connection at 128 Kbits/sec and 2:1 compression, the user can read back a non-cached 1 Mbyte file in approximately 40 seconds.

Configuration data of the gateway appliance is stored at the data repository 201, so that in the event of catastrophic failure of a gateway device, a new gateway device can be reinstalled, and reconfigured according to the configuration date retrieved from the data repository 201. The configuration data includes customer-specific settings of a gateway appliance 200.

Sending only blocks of data which have changed since a last transmission between the gateway appliance and the data repository drastically reduces an amount of data which has to be transferred over the communications link between the data repository and gateway appliance. This enables the gateway appliance to provide a file emulation service to the plurality of networked computers, using a relatively low bit rate capacity communications link.

Blocks of data from a cached file stored at the gateway appliance which are transmitted over the communications link, are compressed prior to transmission. In order to carry out the compression prior to transmission, the gateway appliance must catalog changes in a file, and record how a file has changed, after a previous transmission event, in order that only the changed portions of the file are compressed and transmitted over communications link.

As an alternative to decompressing received partial files representing updates to user files, decompressing the original user file at the data repository, merging the files to obtain a new updated file and then recompressing the new updated file, the data repository may simply treat the incoming packages as being packages to be simply filed away without any merging or processing. In this case, on retrieval, the data repository may represent a compressed encrypted package representing an original user file, plus encrypted compressed update packages to that user file, upon demand from the gateway appliance. The gateway appliance may then have the job of processing by decompressing and decrypting the original user data file, and then incorporating all the updates received from the data repository, after decompression and decryption of those updates, to reconstitute the actual up-to-date user data file.

Received data packages stored at the data repository representing upgrades to user data files may be purged after a predetermined number of such files are received. Purging may be by combining the earliest versions of upgrade files. For example, when a predetermined number, e.g. 30 upgrade files are received, in order to avoid storing more than a preset number of upgrading files, the earliest upgrade file versions may be merged together. Such technology is already applied in conventional back up systems, for example Hewlett Packard Auto Backup systems, and may be applied in the data repository.

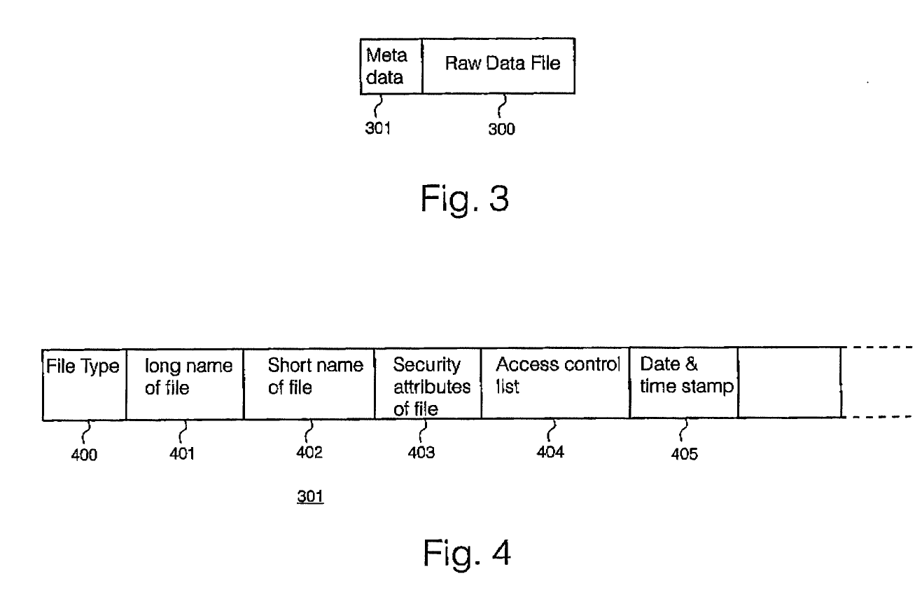

Referring to FIG. 3 herein, there is illustrated schematically an example of a data packet compiled by gateway device 200, for sending over the internet as plurality of TCP/IP packets, for receipt by the data repository 201. The data packet comprises a raw user data file 300, which contains the actual data to be stored; and a meta data header 301. Meta data header 301 contains enough information for the gateway appliance 200 to identify the raw data so that the gateway appliance, in conjunction with the data repository, can search for individual data blocks which have been stored in the data repository.

The meta data 301 is specific to a particular type of operating system of a user. The number and content of the data fields in the meta data are created specific to each different operating system supported by the data repository 201.

Referring to FIG. 4 herein, there is illustrated schematically individual data fields within meta data header 301. Individual data fields include a file type data field 400 identifying a file system type, for example whether the network filing system is an NT-type file system, a NetWare-type file system, a Unix-type file system or the like; a long name of the file 401; a short name of the file 402; security attributes of the file, which allow users access or deny access to particular users of the file such as; an access control list 404 for controlling access to the files, e.g. whether the file is allowed to be read or written or deleted; and a date and time stamp 405 marking the date and time when the file was created, and/or the date and time a file was modified.

The meta data header is a superset of all the possible file attributes which would be available in all the supported file system types in the gateway. For example supposing the gateway appliance supports just Windows NT and NetWare file systems, then the meta data produced by that gateway appliance would be a superset of the attributes from both those file systems.

The file names are preferably based on the file system of the network which the file originates. For example, if the file system used in the repository is Unix, but the file system used on the computer network is DOS, DOS file names can only be 8 characters, with 3 characters for the extension, whereas Unix file names are efficiently limited. For a transmission file sent from a DOS based computer network, be meta data would have a DOS name. As another example, supposing the user's computer network operates a Windows NT™ file system, the gateway appliance emulates a Windows NT file system, therefore the naming system is based on Windows NT. If the data repository cannot store data files in that format, then the information that the file should be seen as a Windows NT file is stored in the meta data header.

The actual name of the transmission file contained in the meta data can also impart information to the data repository. For example, the file names can be used to search data blocks within the data repository to find files which are controlled by a particular gateway appliance.

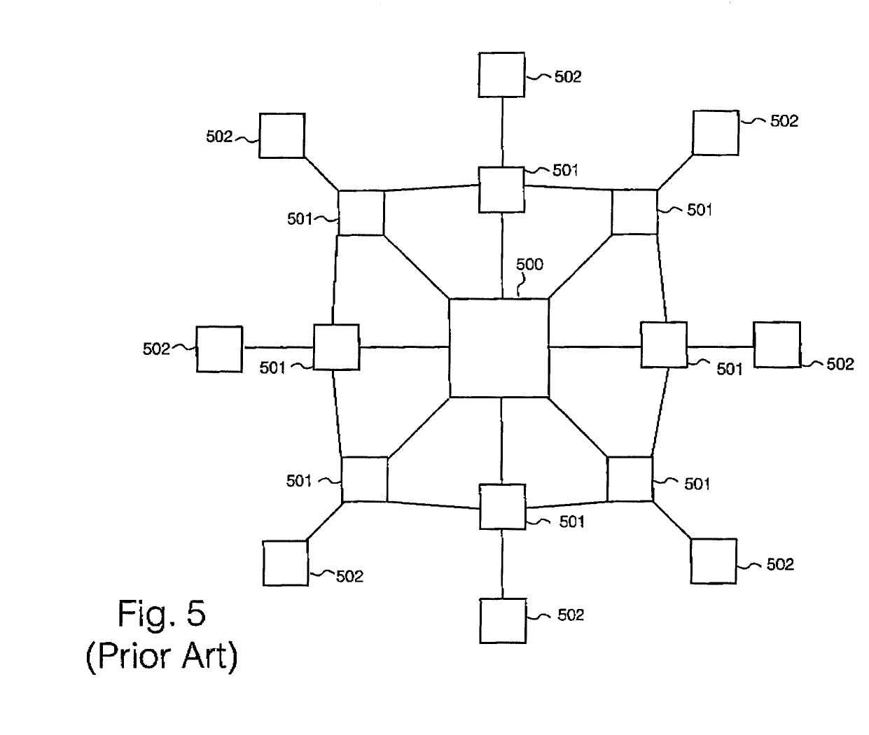

Referring to FIG. 5 herein, there is illustrated schematically a prior art data storage facility which may be incorporated into data repository 201. The prior art data storage device comprises a high capacity, high reliability bulk data storage unit 500, which may comprise an array of rotating hard disk drives; a plurality of file servers 501 for managing file handling and configuraton of the data storage unit 500; each file server 501 having a gateway port 502 for connecting to a communications link for example an internet connection. The bulk data storage unit 500 may be based upon a known storage area network (SAN) which comprises a plurality of data storage devices and a fiber channel network. The SAN may be easily scaled up by adding more data storage components to the fiber channel network. However, in the general case, the data storage device 500 could be any type of distributed networked storage, having the characteristics of high reliability, high data storage capacity and having facility for scalability so that the data storage capacity can be expanded easily by addition of individual data storage disk drives, without significant loss of performance. It will be appreciated by those skilled in the art that technologies such as storage area networks, and file server clusters, are known in high-end Unix systems utilized in large corporate networks. Such systems are available from Hewlett Packard Company. The data storage unit 500, file servers 501, and gateway devices 502 are interconnnected, to provide a high capacity, high reliability data storage repository. Internet connections provided through gateway devices 502 may be added in a scaleable manner, depending upon how many customers are to be connected to the cluster. Entry into the cluster by any one of the internet connections at any gateway allows access to any of the individual file servers 501 within the cluster.

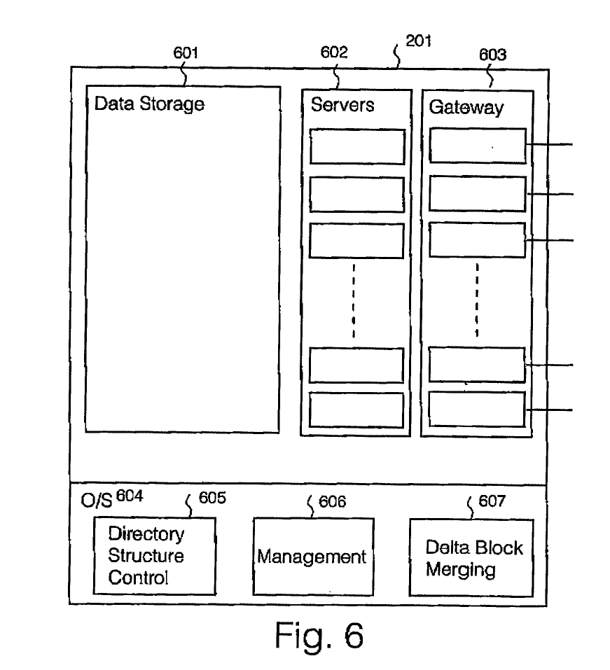

Referring to FIG. 6 herein, there is illustrated schematically an architecture of a data repository facility device 201 according to a specific embodiment of the present invention. The data repository facility comprises a bulk data storage unit 601 as herein before described, comprising a plurality of file servers 602 and a plurality of gateway ports 603, which may be configured in a known layout as shown in FIG. 5. The data repository also comprises an operating system 604 comprising a directory structure control module 605 for controlling a structure of file directories within the data storage 601; a management module 406 for managing overall control of the data repository, and a delta block merging module 607.

The operating system 6O4 in the data repository has to perform main functions as follows:

When the operating system receives a data transmission file from a gateway appliance, the operating system names the file and stores it in a specific directory in the data storage unit so that the received data transmission file is associated with a particular gateway appliance from which it originated.

The repository adds its own attributes to the received data transmission file. These are part of the repository file system and are not necessarily an integral part of the data transmission file.

The data repository must be able to maintain security systems for file access according to a user's security policies on their network.

In terms of the data repository file system the raw data is stored in bulk data blocks, assigned to a customer's gateway appliance, and the meta data is held in a file system as part of the repository file system structure. For example there is a directory listing of which files are in data repository, what directories they are in, which physical blocks on disk the raw data files are located at.

In the data repository, individual blocks of data can be configured to be viewed by a user as belonging to any particular type of operating system, for example a first block of data may be configured to be viewed as an NT file system, a second block of data may be viewed by a user to be a NetWare™ filing system. From the user's point of view, the data blocks are expandable in terms of memory size, whilst keeping the same file structure.

From the point of view of the service provider running and managing the data repository, the service provider does not want to be involved directly in how the data storage is used by the plurality of users, and in particular the service provider does not want the system overhead of deciding which file system types and sizes a user of the data repository requires, and does not want to become involved in determining what authorizations different individuals within a corporation have in using a block of data storage allocated to a corporate user, or become involved in the details of information security of individual corporate users. The data repository may be handling up to Petabytes of data, therefore any management of the data storage space by the service provider is likely to give the service provider higher administration costs.

To address the problem of management of data within the data repository, in the best mode according to the present invention, configuration of data storage space is, as far as possible, put under control of users of the client computer networks by virtue of file handling by the customer's gateway appliance, with, as far as possible, management of data storage space at the data repository being limited to serving out blocks of data storage. The repository needs to be able to handle allocation of data storage space to individual users, and storage of data blocks in that space, whereas the gateway appliance needs to be able to present the remote data storage facility to users in a file structure compliant with the file system of the operating system on the local area network. Because of the limitations of the communications link, transfer of data over the communications link requires compression of data. This is done at the level of individual blocks of data.

Data management module 606 monitors how much data so space each individual customer is using, and can calculate invoices according to how much data storage space is being used.

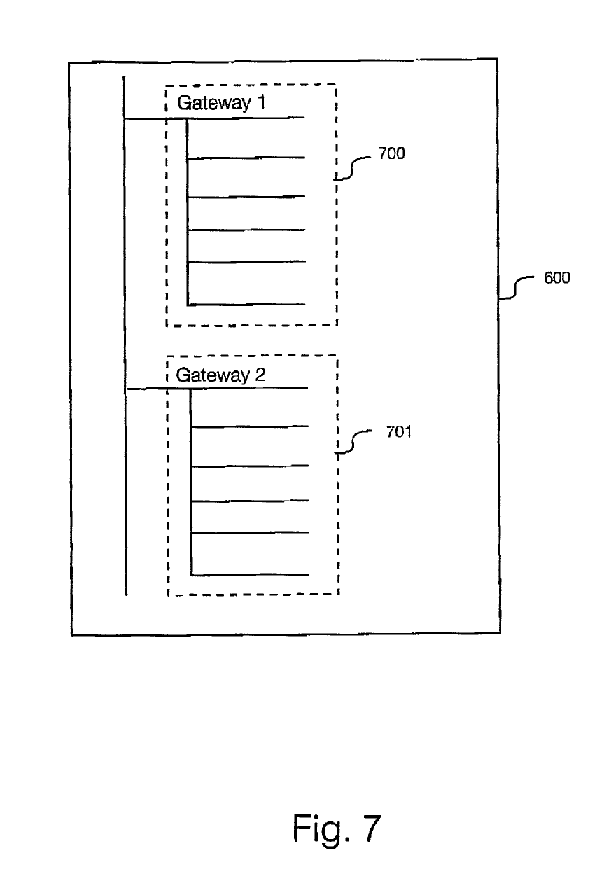

Referring to FIG. 7 herein, there is illustrated schematically a file structure applied within data repository 201. Each gateway appliance 200 of each user is allocated a data block 700, 701 reserved for exclusive use of that corresponding respective gateway appliance. Within the data block 700, individual received data transmission packets are stored in locations which are allocated by management module 606. The locations may be allocated sequentially, depend upon a date and timestamp of the data packet received from the gateway appliance. Directory structure control module 605 maintains a database listing of:

Locations of data blocks assigned to each of a plurality of gateway appliances

Within those data blocks, location of individual data packets received from that gateway appliance

Data packets are stored and retrieved from the data storage area by management module 606, which is able to locate those data packets by reference to the internal location database stored in the directory structure control module 605.

One reason for grouping the files in the manner shown in FIG. 7 is so that a service provider can see how much data storage space a particular customer is using.

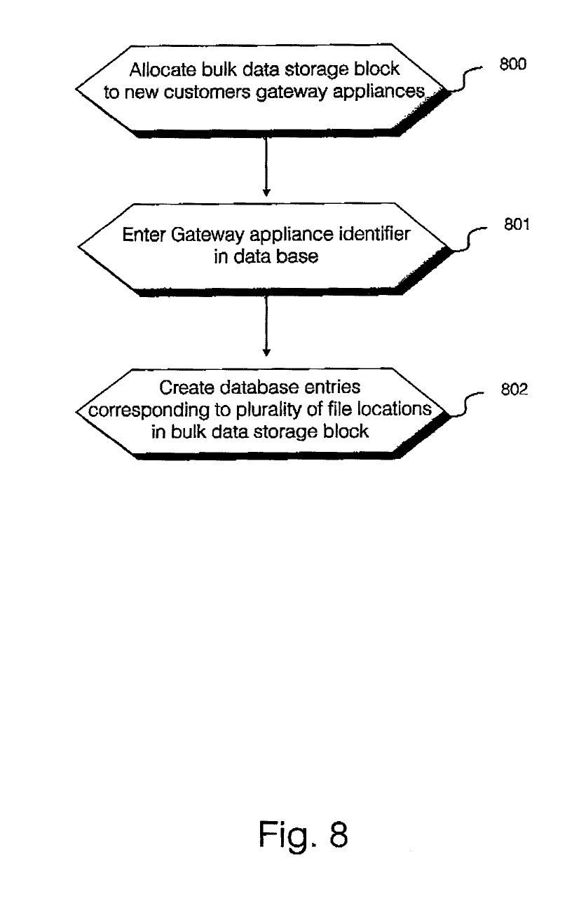

Referring to FIG. 8 herein, there is illustrated schematically a method for set up of a new data block 700 for a new gateway appliance. In step 800, a human operator accessing management module 606 via a user interface comprising a visual display, keyboard and pointing device, for example a mouse, creates a new data block 700, from a dropdown menu presented on screen, and generated by management module 606. In step 801, management module 608 enters a gateway appliance identifier data, identifying the customer's gateway appliance, into the database. In step 802, within the database, a plurality of individual file locations are allocated, corresponding to a plurality of individual file locations in the data storage block 700.

If a customer requires more data storage, then using the management module 606, a human operator at the data repository 600 can simply create more database entries corresponding to more file locations in the bulk data storage block, thereby increasing the size of the data block available to the customer.

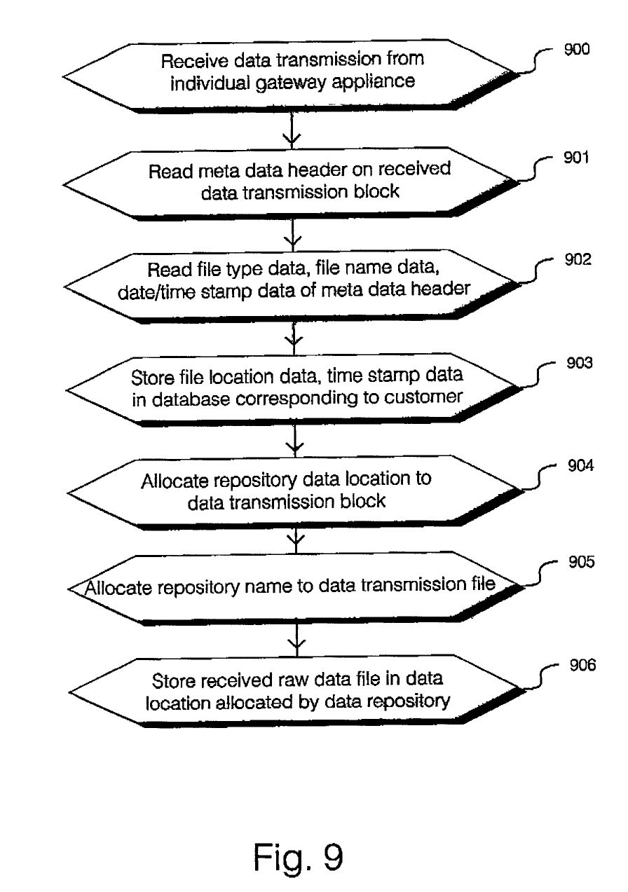

Referring to FIG. 9 herein, there is illustrated schematically handing of a data transmission block by the operating system 604 of the data repository. In step 900, the repository receives a data transmission block from any one of the plurality of gateway appliances which the repository serves. In step 901, the management module 606 reads the meta data header on the received data transmission block, and in step 902, reads the file type data, file name data, date/time stamp data of the meta header, and passes this to the directory structure control module 605. In step 903, the directory structure control module 405 stores file location data and time stamp data in a database location corresponding to the individual customer from which the data transmission file has been received. In step 904, there is allocated a data storage location in the repository data storage area to the transmission file received from the customer. In step 905, the received data transmission file is stored in a data location allocated to the customer, according to the file structure as illustrated with reference to FIG. 7 herein.

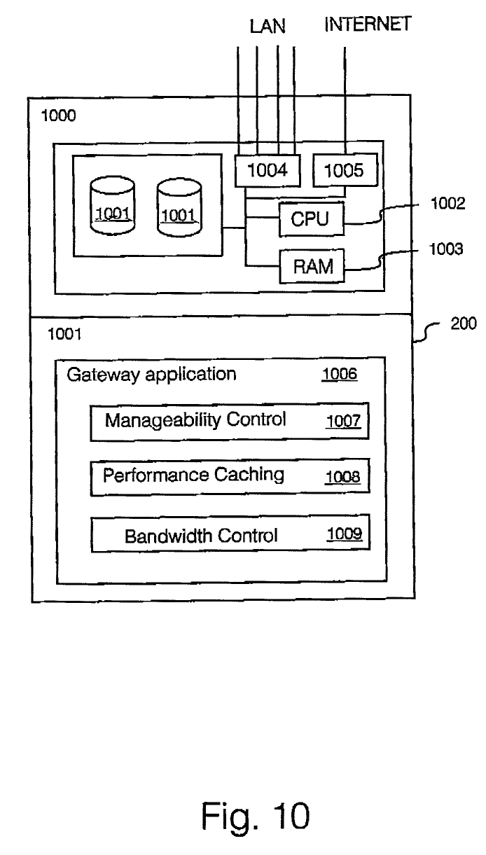

Referring to FIG. 10 herein, there is illustrated schematically an architecture of a gateway appliance 200. Gateway appliance 200 comprises a hardware platform 1000 and an operating system 1001. Hardware platform 1000 comprises an amount of local data storage in the form of one or a plurality of hard disk drives 1001; a processor 1002, an associated random access memory 1003; a local area network port 1004; and a communications link port 1005, for connecting, for example, with the internet. The operating system, in addition to a conventional operating system such as Unix, Windows of the like, comprises a gateway application 1006 comprising a manageability control module 1007; a performance caching module 1008; and a bandwidth control module 1009.

The gateway application 1006 operates to emulate a file system corresponding to a file system of a network of computer entities to which the gateway appliance is connected; cache data files from the network, prior to sending data files to the data repository, so that often used files can be held locally at the gateway appliance between data storage operations; apply conversion of user data files from file system dependent format to file system independent format of data, so that file in dependent format data is sent to the data repository, whilst file type dependent data is communicated to the network computer entities; and compress/decompress data prior to and after transmission over the communications link.

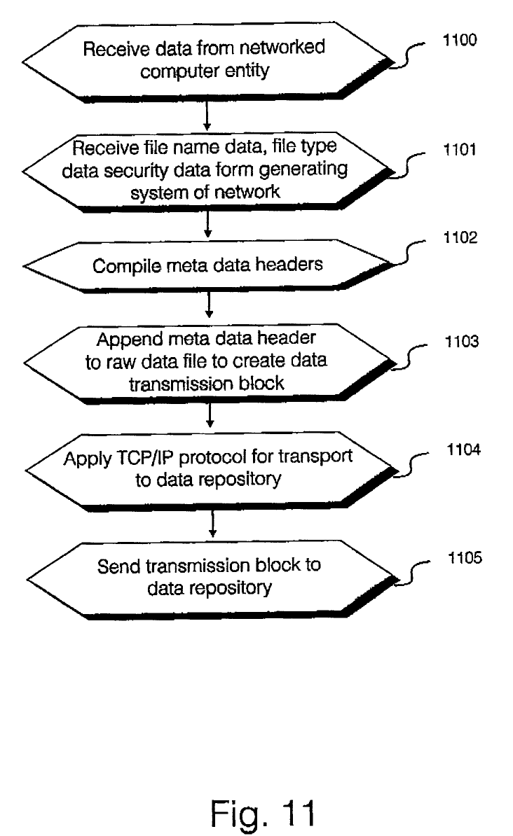

Referring to FIG. 11 herein, there is illustrated schematically a first method of operation of gateway appliance 200. In step 1100, a user stores a file at a local client computer within the user network, in accordance with the operating system of that network. Data is received from the network client computer entity by the gateway appliance in step 1100 over the local area network. In step 1101, the gateway appliance interrogates the operating system for the file name, file type, and security data relating to the file, and generates file name data, file system type and file type data and security data. In step 1102, the gateway appliance compiles a meta data header, filling in the individual data fields for file system and file type, long name of file, short name of file, security attributes of the file, and access control to the file, and applies a date and time stamp to the file. In step 1103, the gateway appliance appends the meta data header to the raw data file to create a data transmission file as illustrated in FIG. 4 herein. In step 1104, the data transmission file is passed down to a transport layer within the gateway appliance, and may be sent over the internet connection either as a TCP/IP packet stream, or a series of ATM cells as is known in the art. In step 1005, the transmission file is sent over the network connection in the selected protocol, e.g. TCP/IP, or ATM.

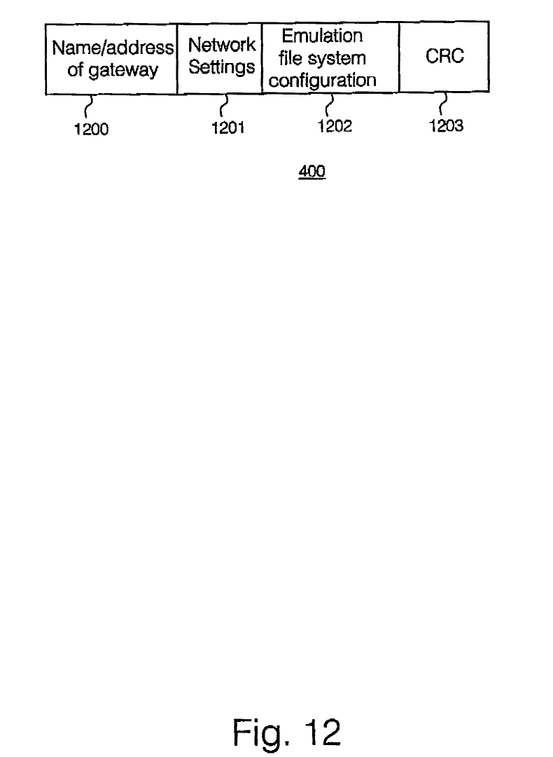

Referring to FIG. 12 herein, there is illustrated schematically the file type data 400 contained in the meta data header 301. The file type data comprises a name and address field 1200 containing a logical address of the gateway appliance originating the data transmission block; a network settings field 1201, which stores all the settings of the user's network, for example security authorizations, assignment of printers to individual computer entities connected to internet services and the like; and an emulation file system configuration field 1202 containing data describing how the gateway appliance is configured to emulate a particular file system configuration, for example a Windows NT-based file system, or a Unix-based file system; and a cyclical redundancy code check 1203 for recovering any of the name and address field, network settings field or emulation field data in the event of data corruption of the file either during transmission, or as a result of storage in the data repository.

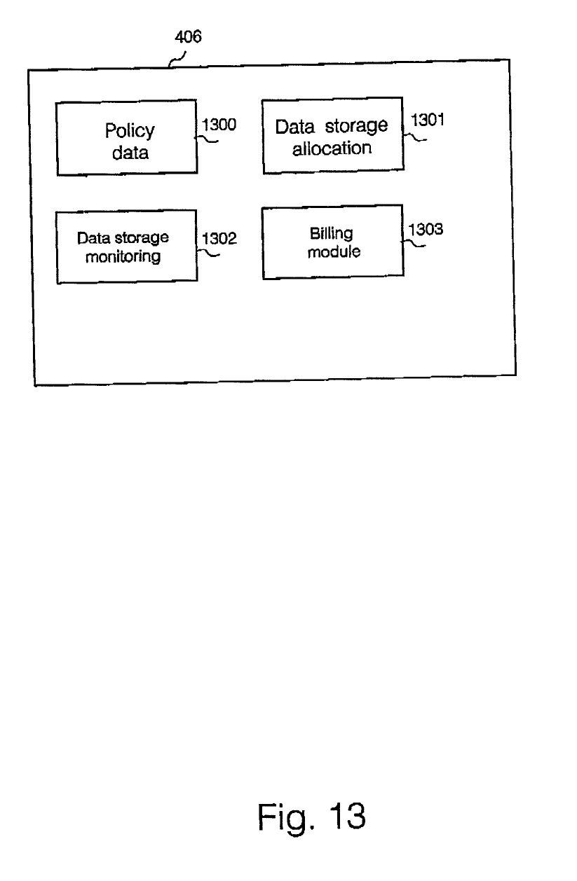

Referring to FIG. 13 herein, data management module 606 comprises a policy data table 1300, which stores policy data for each of a plurality of customers. Such policy data may include for example a maximum amount of data storage space which a customer has contracted to use in the data repository. Data allocation module 1301, allocates data storage to individual customers, as data packets are received from those customers. Monitoring module 1302 monitors the allocation of data storage space in the repository to individual customers. If a customer attempts to exceed their data storage allocation by sending data storage packets which would cause overflow of their allocated data storage space, the data storage monitoring module 1302, having knowledge of the maximum capacity allocated to that customer by reading policy data 1300 may generate a ‘refuse storage’ message which refuses storage of the next incoming data packet from a customer where this would cause overflow of that customer's allocated data storage block.

Billing module 1303 may calculate an invoice amount for which a customer is to be invoiced, which depends upon the amount of data storage space that customer has used, and the time period over which that data storage space has been used. Bearing in mind that files may be stored or retrieved at any time, a unit of calculation upon which a monetary value of invoicing is calculated may be gigabyte minutes, that is to say storing 1 gigabyte of customer data for 1 minute incurs a monetary charge.

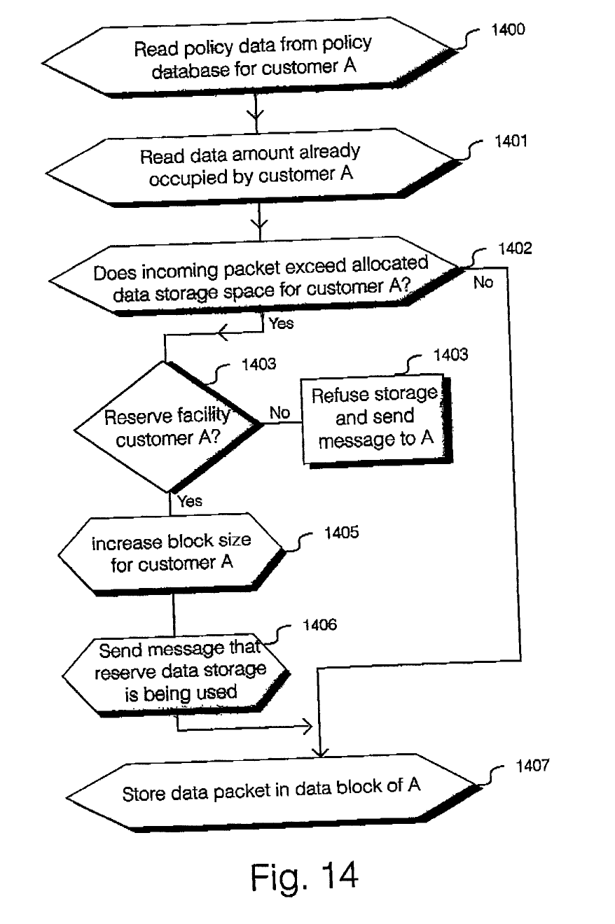

Referring to FIG. 14, there is illustrated schematically operation of the operating system 604 of the data repository for managing data storage capacity of a customer A. In step 1400, on receiving a data packet from customer A, policy database 1300 is read to find out what policies are applied to a data storage block corresponding to customer A. In step 1401, the capacity of data already occupied in the data block of customer A by data packets received from customer A is read. In step 1402, the data packet, which is stored in a buffer as it is received, is read, and if the addition of the data packet to the existing data in customer A's data block will exceed the allowed size of customer A's data block, then in step 1403 it is checked from the policy database 1300 whether a reserve data storage facility is available for customer A. If a reserve data storage facility is not available, then in step 1404, the repository refuses to store the incoming data packet and sends a message to the gateway appliance of customer A informing that storage of the packet would exceed the agreed data storage amount. If customer A does have a reserve facility, then in step 1405 the size of the data block allocated to customer A is increased, and in step 1406 a message is sent to the gateway appliance of customer A, that the reserve data storage facility is being used. In step 1407, the data packet is stored in the now enlarged data block allocated to customer A. However, if in step 1402, storage of the incoming data packet would not exceed the available free space within the reserve data block for customer A, then the data packet is stored in that data block as herein described.

1. A method of storing user data of a plurality of network computer entities, said method characterized by comprising the steps of:
writing said user data to a local data storage area (1001) in a said computer entity;
creating an emulation data which emulates a file system type in use in said network;
incorporating said user data and said file system type data in a data file for transmission; and
transmitting said transmission file over a communications link for remote data storage.

2. The method as claimed in claim 1, wherein said emulation data comprises data describing security attributes of said user data.

3. The method as claimed in claim 1 or 2, wherein said step of transmitting a said transmission file comprises transmitting a plurality of modified portions of user fees which have changed since a last transmission event.

4. The method as claimed in claim 1, wherein said step of transmission occurs at predetermined intervals, and said step of writing user data comprises caching said user data in said local data storage device between file transmission events.

5. The method as claimed in claim 1, wherein said user data is cached in a file at said local data storage area (1001) in a file system independent format; and periodically, a portion of said file which is changed compared to a previously transmitted version of said file is transmitted over said communications link for remote data storage.

6. The method as claimed in claim 1, wherein a said transmission file comprises a block of a user data file representing incremental changes of said user data file, and said changes of said user data file are received in compressed format and further comprising the steps of:
decompressing said changed block of user data;
decompressing a received full said transmission file;
combining said decompressed changed block of user data;
decompressing said full transmission file;
updating said full transmission file by incorporating said changed block of user data to obtain an updated data file; and
recompressing said updated data file.

7. The method as claimed in claim 1, wherein prior to said step of transmitting said transmission file over said communications link, said transmission file is compressed and encrypted.

8. The method as claimed in claim 1, further comprising the step of:
maintaining said data file for transmission in said computer entity in which said user data is written to a local data storage area;
receiving an incremental change to said user data file;
modifying said user data file by incorporation of said incremental change data prior to said step of transmitting said transmission file over said communications link for remote data storage.

9. The method as claimed in claim 1, further comprising the steps of:
receiving from remote data storage location:
a compressed encrypted package representing a user data file;
one or more compressed encrypted packages representing updates to said user data file;
decompressing and decrypting said received package representing a said user data file;
decompressing and decrypting each said package representing an update of said user date files;
combining said user data file with said updates of said user data file to obtain an updated user data file, reconstituted from said data packages received from said remote data storage device.

10. A method of preparing data originating from a plurality of networked computer entities into a format suitable for remote storage, said method characterized by comprising the steps of:
assembling a file of user data to be remotely stored;
assembling a header data (1102), said header data comprising:
an address data (401) identifying an address of a device from which said data is sent;
a file system type data (400) identifying a file system type which is used by the device from which the data is sent;
an access control data (404) describing at least one category of user who is authorised to access said user data files;
a timing data (405) identifying a time associated with said user data file; and
appending said header data (1103) to said user data file to create a transmission file comprising sad user data file and said header data.

11. The method as claimed in claim 10, wherein said file system type data comprises:
an identifier data (1200) identifying an address of said device originating said data;
a network settings data (1201) specifying internal network settings of said computer network from which said data originates;
an emulation file system configuration data (1202), describing an internal set-up of a gateway device sending said data, said set up data describing how said gateway device emulates a file server system.

12. The method as claimed in claim 10, further comprising the step of:
storing said file system type data at a remote storage device, remote from a said computer entity originating said transmission file.

13. The method as claimed in claim 10, further comprising the steps of:
transmitting to a remote data storage facility stored configuration data including customer-specific gateway appliance settings, arranged to configure a said gateway appliance according to a specific customer requirement.

14. A gateway appliance for sending data to and receiving data from a remote data storage location accessible over a communications link, said gateway appliance characterized by comprising:
a data processor (1002);
a first communications port (1004) for communicating with a plurality of computers in a computer network;
a second communications (1005) port for communicating with a remote data storage facility;
a non-volatile data storage device (1001) for storing locally, data to be communicated via said second port;
means (1001) for emulating a file system corresponding to a file system of a network of computer entities;
means for converting data between a file system dependent format and a file system independent format; and
means for converting said data between a compressed format and an uncompressed format.

15. The gateway appliance as claimed in claim 14, wherein said means (1001) for emulating a file system operates to create an emulation data which emulates a file system type of a network of computer entities, in a format suitable for incorporating with a user data file for transmission to a remote data storage device.

16. The gateway appliance as claimed in claim 14, configured to make a scheduled transmission burst of changes to files since a last transmission burst, wherein only blocks inside files which he changed since the last transmission are transmitted in said scheduled transmission.

17. A bulk data storage facility comprising:
a plurality of data storage devices (500, 601);
a plurality of file servers (601, 602) configured for storing data in said plurality of data storage devices;
a plurality of gateway devices (502, 603) providing external connectivity to said plurality of file servers and adapted to receive packets of incoming data;
said bulk data storage facility characterized by comprising:
means (604) to allocate said plurality of incoming data packets to data storage space in said plurality of data storage devices; and
database means (1301) for recording a data location of each said plurality of data packets in said plurality of data storage devices.

18. The bulk data storage facility as claimed in claim 17, configured to:
receive incremental changes of pieces of user file data noting changes to at least one user data file; and
allocate locations to said incremental pieces of user files in said data storage space.

19. The bulk data storage facility as claimed in claim 17, further comprises:
means (1302) for monitoring how much data storage space is allocated to each of a plurality of customers.

20. The bulk data storage facility as claimed in claim 17, further comprising means (1303) for calculating a monetary cost of a data storage space allocated to each of a plurality of customers.

21. A method of providing data storage to a plurality of customers at a bulk data storage repository, said method characterized by comprising the steps of:
receiving packages of data from each of said plurality of customers;
allocating (800) to each said customer at least one block of data storage space;
allocating to each said received package a file location in said data storage space;
allocating to each said package a file name;
storing (802, 1407) said file name in a database, said database identifying said file location in said data repository associated with said data packet.

22. The method as claimed in claim 21, further comprising the step of:
reading a policy data (1400) from a policy database containing policy data governing allocation of data storage space to each of a said plurality of customers;
determining (1402) if storage of said received package in a data block allocated to a said customer would exceed an allowed data storage capacity of said customer;
increasing (1405) said data block allocated to a said customer.

23. The method as claimed in claim 21, further comprising the step of:
reading a policy data (1400) from a policy database containing policy data governing allocation of data storage space to each of a said plurality of customers;
determining if storage of said received package in a data block allocated to a said customer would exceed an allowed data storage capacity of said customer (1403).
if storage of said data package would exceed said predetermined data block size allocated to said customer, overwriting said received package

24. The method as claimed in claim 21, wherein said received packages are received and stored by said bulk data storage facility in compressed format.
